(19) United States
(12) Patent Application Publication
(10) Pub. No.: US 2012/0268613 A1
(43) Pub. Date: Oct. 25, 2012

(54) IMAGE CAPTURING APPARATUS AND CONTROL METHOD THEREOF

(75) Inventor: Akihiro Nishio, Yokohama-shi (JP)

(73) Assignee: CANON KABUSHIKI KAISHA, Tokyo (JP)

(21) Appl. No.: 13/440,526

(22) Filed: Apr. 5, 2012

(30) Foreign Application Priority Data
Apr. 21, 2011 (JP) 2011-095280

(51) Int. Cl. H04N 5/225

(52) U.S. Cl. 348/208.5; 348/E05.024

(57) ABSTRACT

An image capturing apparatus receives, using an imaging device, light fluxes passing through different areas of an exit pupil of an optical system independently and output an image signal obtained therefrom, calculates a correction value for the image signal corresponding to each of the different areas of the exit pupil to correct an influence from vignetting on the light fluxes due to shift of a shake correction unit in response to activation of the shake correction unit which corrects an image blur corresponding to a shake amount exerted on the image capturing apparatus, corrects the image signals using the calculated correction value, and performs focus control on a basis of a phase difference between the image signals which are subjected to correction.

### BACKGROUND OF THE INVENTION

1. Field of the Invention

The present invention relates to image capturing apparatuses and control methods thereof, and more particularly relates to image capturing apparatuses equipped with a shake correction function and configured to perform focus control by a phase difference detection method based on an image signal obtained from an imaging device and control methods thereof.

2. Description of the Related Art

Recently live-view photography in which a photograph is taken while viewing a subject image formed on imaging pixels in real-time at the time of capturing still or moving images is becoming popular.

For live-view photography, autofocus control by a contrast method has been widely used in which a subject image is photoelectrically converted at the imaging pixels, and a focus state of the subject image is determined by detecting a contrast change of the subject image with reference to a focus change of a photographing optical system. In the contrast method, however, since a focus state is detected while performing focus control processing, a focus lens cannot be driven quickly.

To cope with this, an image capturing apparatus capable of performing focus control by a phase difference detection method is proposed, in which a plurality of photoelectric conversion devices are formed in each pixel of an imaging device, and a signal is read out from each photoelectric conversion device to obtain a pair of image data pieces having a phase difference therebetween (see Japanese Patent Laid-Open No. 2004-191629, for example). Such an image capturing apparatus can achieve quick focus lens driving.

In such focus detection processing by the phase difference detection method, concurrently with focus detection, an image received by the imaging device can be live-view displayed in real time or moving images can be photographed. Meanwhile, for image recording in real time, an aperture value of the photographing optical system has to be changed with the brightness of a subject image. For this reason, the diaphragm cannot be always held in a full-open state for focus detection.

Then, the following problem occurs. As the effective F-number of the photographing optical system is increased (darkened) by a stop-down operation during photographing, the exit pupil range of the photographing optical system is made smaller. As a result, vignetting occurs in some cases in light captured for focus detection. Then electric signals (hereinafter called “image signals”) captured at focus detection pixels varies, and accordingly a relationship of the phase shift variation to the focus shift variation (base-line length) varies and an error occurs in correlation of image signals. Additionally, when focus detection is performed using image signals from focus detection pixels placed at an image height at a periphery of the image area of the photographing optical system having a tendency of decreased aperture efficiency, photo vignetting occurs.

To cope with these problems, Japanese Patent Laid-Open No. 2004-191629, for example, proposes a method of acquiring photo vignetting information on the photographing optical system during focus detection and correcting image signals for focus detection.

Meanwhile, along with the recent tendency to seek more compact image capturing apparatuses and optical systems of higher power, shake of the image capturing apparatuses are becoming a major cause of degradation of the quality of captured images. Focusing on this, various shake correction functions have been proposed to correct the blur of a captured image due to the shake of the apparatus. As one example of conventional shake correction functions incorporated in image capturing apparatuses, a correction method using both of an optical image stabilization method and an electronic image stabilization method is available (see Japanese Patent No. 2803072, for example).

Firstly the optical image stabilization functions to detect shake of the image capturing apparatus and drive an optical system for image stabilization to cancel the detected shake so that subject light incident on the imaging device is located always at the same position on the imaging area. Next the electronic image stabilization functions to find blur between images so as to detect the remaining shake that cannot be corrected with the optical image stabilization method and move a reading area of the image so as to cancel the found blur between images, thus correcting the remaining shake of low frequencies.

In the optical image stabilization method, however, a correction lens group of the optical system is decentered, and such a decentered correction lens group further changes photo vignetting and adversely affects the focus detection accuracy.

### SUMMARY OF THE INVENTION

The present invention has been made in consideration of the above situation, and the present invention provides an image capturing apparatus enabling high focus detection accuracy even when the image capturing apparatus uses a photographing optical system provided with the aforementioned image blur correction mechanism.

According to the present invention, provided is an image capturing apparatus, comprising: an imaging device configured to receive light fluxes passing through different areas of an exit pupil of an optical system independently and output an image signal obtained therefrom; a calculation unit configured to calculate a correction value for the image signal corresponding to each of the different areas of the exit pupil to correct an influence from vignetting on the light fluxes due to shift of a shake correction unit in response to activation of the shake correction unit which corrects an image blur corresponding to a shake amount exerted on the image capturing apparatus; a correction unit configured to correct the image signal corresponding to each of the different areas of the exit pupil using the correction value calculated by the calculation unit; and a focus control unit configured to perform focus control on a basis of a phase difference between the image signals corresponding to the different areas of the exit pupil, the image signals subjected to correction by the correction unit.

According to the present invention, further provided is a method for controlling an image capturing apparatus, comprising: a reading step of, from an imaging device configured to receive light fluxes passing through different areas of an exit pupil of an optical system independently and output an image signal obtained therefrom, reading out the image signal corresponding to each the different areas of the exit pupil; a calculation step of calculating a correction value for the image signal corresponding to each of the different areas of the exit pupil read in the reading step to correct an influence from vignetting on the light fluxes due to shift of a shake correction unit in response to activation of the shake correction unit which corrects an image blur corresponding to a shake amount exerted on the image capturing apparatus; a correction step of correcting the image signal corresponding to each of the different areas of the exit pupil using the correction value calculated in the calculation step; and a focus control step of performing focus control on a basis of a phase difference between the image signals of corresponding to different areas of the exit pupil, the image signals subjected to correction in the correction step.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram schematically illustrating a configuration of an image capturing apparatus according to an embodiment of the present invention;

FIG. 2 is an example of a pixel layout in an imaging device according to the embodiment;

FIG. 3 is another example of a pixel layout in an imaging device according to the embodiment;

FIG. 4 is still another example of a pixel layout in an imaging device according to the embodiment;

FIGS. 5A and 5B are views for illustrating vignetting due to eccentric-shift of a second lens group;

FIGS. 6A and 6B are views for explaining vignetting at an exit pupil due to eccentric-shift of the second lens group when focus control pixels have the structure of FIG. 2;

FIGS. 7A and 7B are views for explaining vignetting at an exit pupil due to eccentric-shift of the second lens group when pixels have the structure of FIG. 3 or 4;

FIG. 8A illustrates exemplary waveforms of image A and image B of light beams passing through different exit pupil areas when vignetting does not occur;

FIG. 8B illustrates exemplary waveforms of image A and image B of light beams passing through different exit pupil areas when vignetting occurs; and

FIG. 9 is a flowchart illustrating focus detection processing according to the embodiment.

### DESCRIPTION OF THE EMBODIMENTS

Exemplary embodiments of the present invention will be described in detail in accordance with the accompanying drawings.

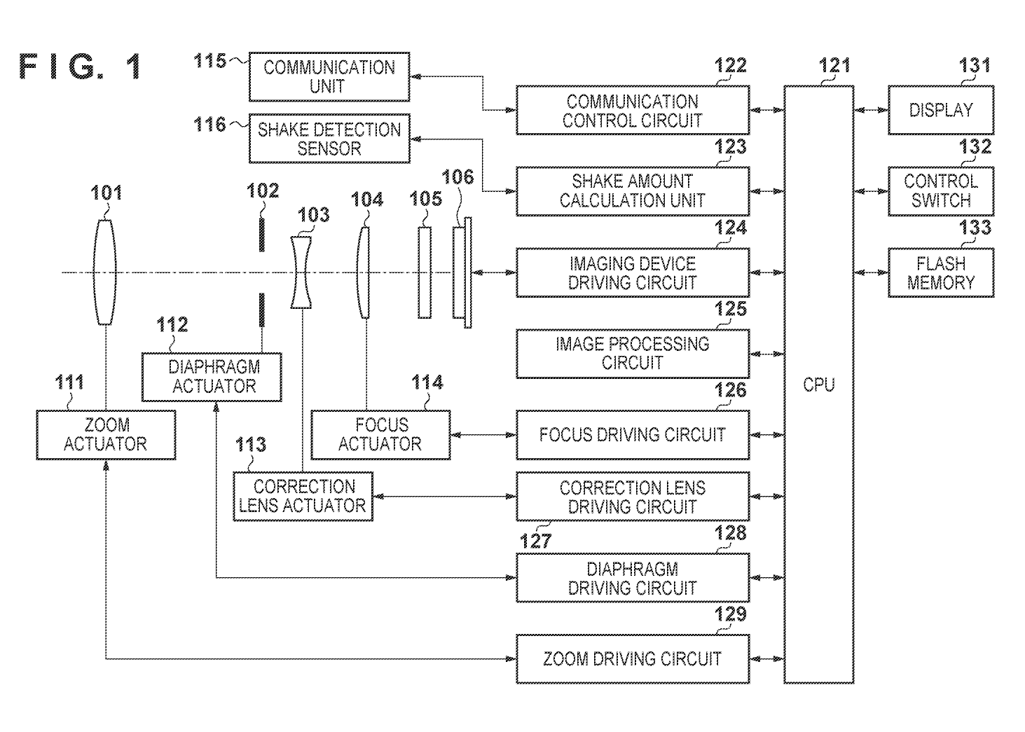

FIG. 1 schematically illustrates the configuration of a digital camera that is an image capturing apparatus including an imaging device according to the present invention, and the digital camera illustrated includes a camera main body including the imaging device integral with or connected with a photographing optical system, and can record moving and still images. In this drawing, reference numeral 101 denotes a first lens group disposed at a forward end of the photographing optical system, which is held to be movable back and forth in the optical axis direction. Reference numeral 102 denotes a diaphragm having an aperture diameter adjustable for light amount adjustment during photographing, and also serving as a shutter for controlling shutter speed when photographing a still image. Reference numeral 103 denotes a second lens group that is a correction lens group having a function of correcting image blur that is caused, for example, during handheld photography by eccentric-shifting in the direction orthogonal to the optical axis. Reference numeral 104 denotes a third lens group that moves back and forth in the optical axis direction for focus control.

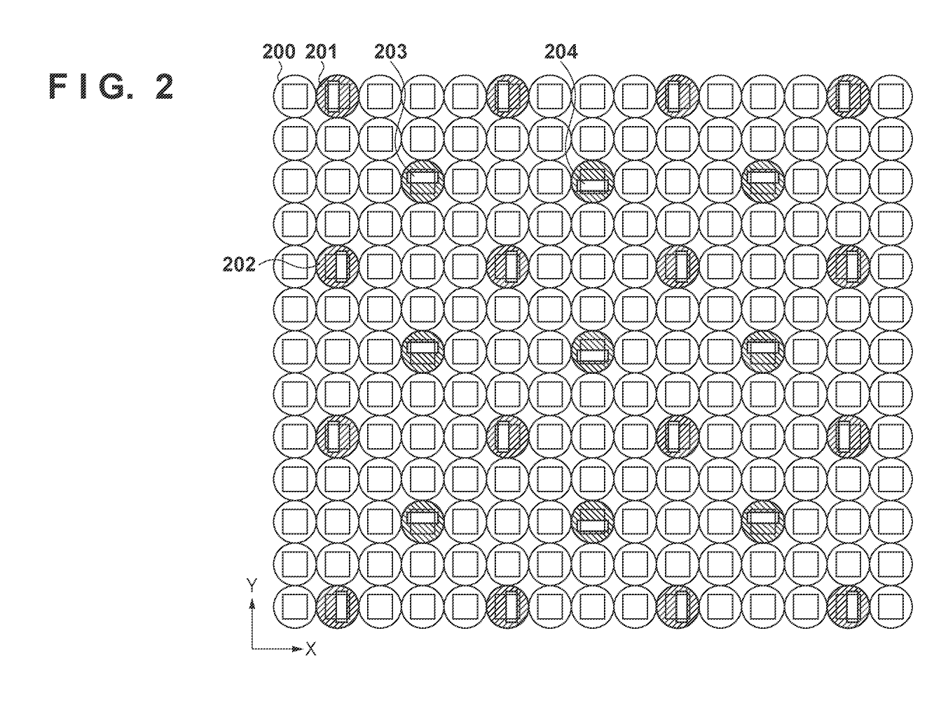

An optical lowpass filter 105 is an optical device to alleviate a false color and moiré of a captured image. Reference numeral 106 denotes an imaging device including a two-dimensional CMOS sensor and a peripheral circuit thereof. The imaging device 106 may be a two-dimensional single-panel color sensor with an on-chip primary-colored mosaic filter in Bayer layout formed thereon including photo-receiving pixels that are square arranged M pixels by N pixels respectively in the horizontal and vertical directions, for example. The structure of pixels making up of the imaging device 106 is described later in detail, with reference to FIG. 2 to FIG. 4.

A zoom actuator 111 rotary-moves a tubular cam not illustrated manually or with an actuator, thus driving the first lens group 101 to the third lens group 104 in the optical axis direction for zoom operation. More specifically, the first lens group 101 to the third lens group 104 are driven so as to change intervals therebetween and change a focal length to implement a zoom function. A diaphragm actuator 112 controls the aperture diameter of the shutter 102 doubling as the diaphragm to control the photography light amount and controls an exposure time during still-image photography. A correction lens actuator 113 eccentric-shifts the second lens group 103, for example, in the direction orthogonal to the optical axis to correct image blur of a subject image formed at the imaging device 106. Normally the correction lens actuator 113 shifts the second lens group 103 biaxially at right angles to deal with a change of the image blur direction with reference to the imaging device 106 on the basis of the synthesized shift amount (eccentricity amount) and such a shift direction. A focus actuator 114 drives the third lens group 104 back and forth in the optical axis direction for focus control.

A wireless communication unit 115 includes an antenna and a signal processing circuit to communicate with a server computer via a network such as the Internet. A shake detection sensor 116 includes an angular velocity sensor such as a gyro sensor, for example, that detects shake exerted to the apparatus by shake of a hand or a body, for example, as a shake signal and outputs the shake signal.

Reference numeral 121 denotes a CPU in the camera for various controlling of the camera main body, including an operation unit, a ROM, a RAM, an A/D converter, a D/A converter, a communication interface circuit and the like. The CPU 121 drives various circuits of the camera in accordance with a predetermined program stored in the ROM to execute a series of operations such as AF, photography, image processing and recording.

A communication control circuit 122 functions to transmit a captured image to a server computer or receive an image and various types of information from the server computer via the communication unit 115. A shake amount calculation unit 123 calculates a shake amount on the basis of the shake signal from the shake detection sensor 116. An imaging device driving circuit 124 controls an imaging operation of the imaging device 106 and A/D converts an acquired image signal and transmits the same to the CPU 121. An image processing circuit 125 performs processing of images acquired at the imaging device 106 such as γ-conversion, color interpolation, JPEG compression, and so on.

A focus driving circuit 126 drives and controls the focus actuator 114 on the basis of a focus detection result to drive the third lens group 104 back and forth in the optical axis direction for focus control. A correction lens driving circuit 127 drives and controls the correction lens actuator 113 in accordance with a driving amount found by the CPU 121 on the basis of the shake amount calculated by the shake amount calculation unit 123 to eccentric-shift the second lens group 103. A diaphragm driving circuit 128 drives and controls the diaphragm actuator 112 to control the aperture of the shutter 102 doubling as the diaphragm. A zoom driving circuit 129 drives the zoom actuator 111 in accordance with a zoom operation by a photographer.

A display 131 such as a LCD displays information on a photography mode of the camera, a preview image before photography, an image for checking after photography, a focus-state display image during focus detection and the like. A control switch group 132 includes a power-supply switch, a release (photography trigger) switch, a zoom operation switch, a photography mode selection switch and the like. A removable flash memory 133 records photographed images.

FIG. 2 is an exemplary pixel layout in the imaging device 106 that can be used in the present embodiment. In this drawing, reference numeral 200 denotes pixels to form a captured image, and 201 to 204 denote pixels for focus detection (hereinafter called “focus detection pixels”) each provided with a light-shield structure therein using a technique described in Japanese Patent Laid-Open No. 2009-244862, for example.

In FIG. 2, waveforms of a pair of images (image A and image B) obtained from a group of pixels arranged in a line in the Y-direction having a shape similar to the focus detection pixel 201 and a group of pixels arranged in a line in the Y-direction having a shape similar to the focus detection pixel 202 are used to detect a focus state of a subject having a brightness difference (edge) in the X direction.

Further, in FIG. 2, waveforms of a pair of images (image A and image B) obtained from a group of pixels arranged in a line in the X-direction having a shape similar to the focus detection pixel 203 and a group of pixels arranged in a line in the X-direction having a shape similar to the focus detection pixel 204 are used to detect a focus state of a subject having a brightness difference (edge) in the Y direction.

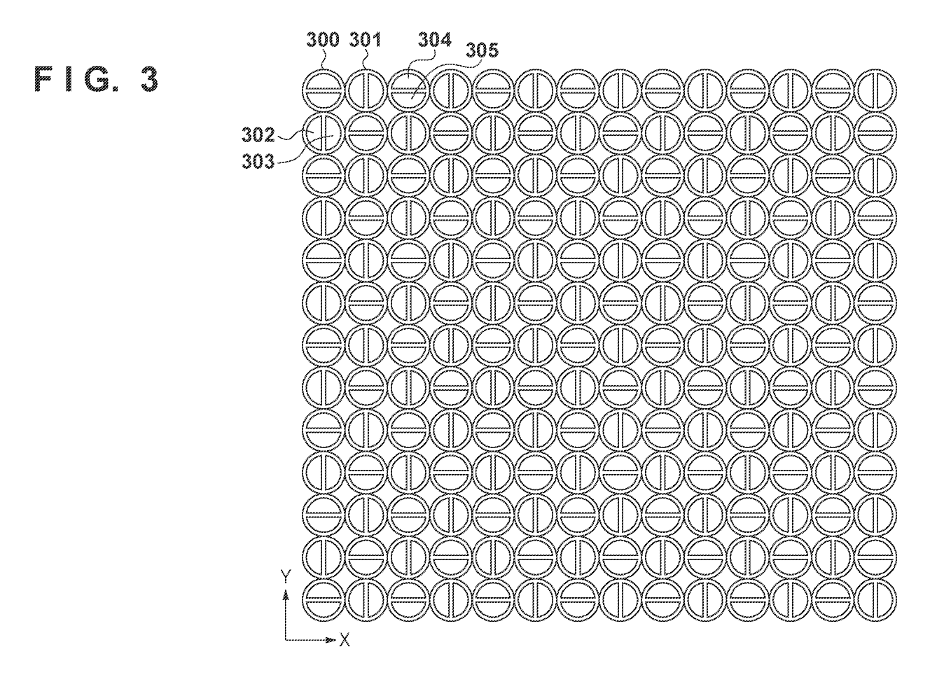

FIG. 3 is another exemplary pixel layout in the imaging device 106 that can be used in the present embodiment. In each pixel, two photoelectric conversion units are provided for each microlens, and each photoelectric conversion unit can output a signal independently. In FIG. 3, it is assumed that the vertical direction is the Y direction and the horizontal direction is the X direction. Then, among a group of pixels having a shape similar to a pixel 300, the waveform of an image (image A) obtained from photoelectric conversion units 304 aligned in the Y-direction and the waveform of an image (image B) obtained from photoelectric conversion units 305 aligned in the Y direction can be used to detect a focus state of a subject having a brightness difference (edge) in the Y direction.

Further, among a group of pixels having a shape similar to a pixel 301, the waveform of an image (image A) obtained from photoelectric conversion units 302 aligned in the X direction and the waveform of an image (image B) obtained from photoelectric conversion units 303 aligned in the X direction can be used to detect a focus state of a subject having a brightness difference (edge) in the X direction.

Then, an image is recorded by adding photoelectric conversion signals obtained from the photoelectric conversion units 302 to 305 for each pixel (i.e., adding photoelectric conversion signals from the photoelectric conversion units 302 and 303 and adding photoelectric conversion signals from the photoelectric conversion units 304 and 305). Thereby, a photoelectric conversion signal for each pixel can be obtained.

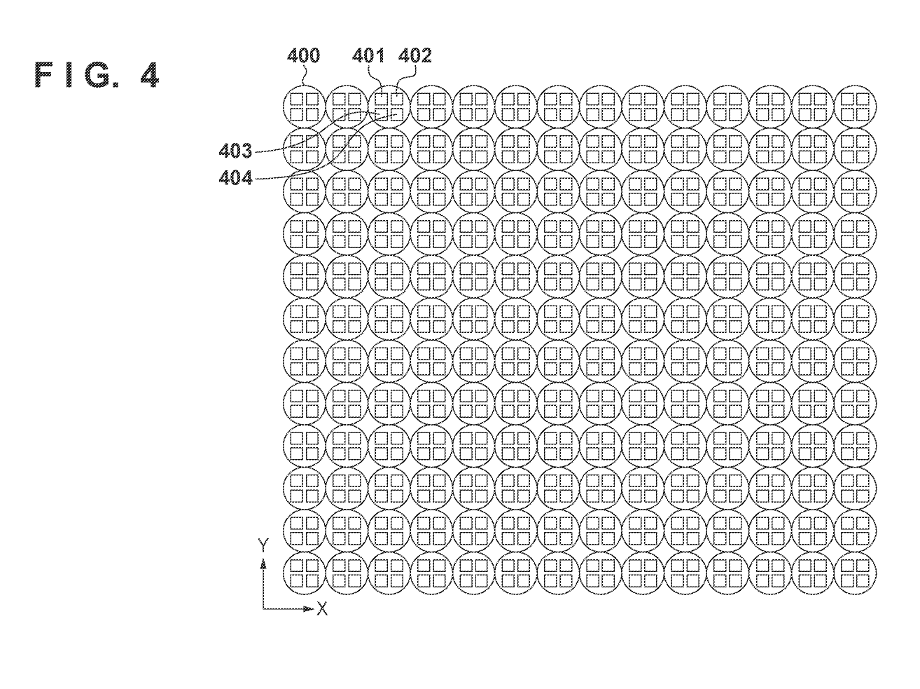

FIG. 4 is still another exemplary pixel layout in the imaging device 106 that can be used in the present embodiment. In each pixel, four photoelectric conversion units are provided for each microlens, and each photoelectric conversion unit can output a signal independently. The combination of the photoelectric conversion signals obtained from these four photoelectric conversion units is changed, such that a focus state as described with reference to FIG. 3 can be detected.

More specifically, in FIG. 4, it is assumed that the vertical direction is the Y direction and the horizontal direction is the X direction. In this case, in a group of pixels having a shape similar to a pixel 400, photoelectric conversion signals obtained from photoelectric conversion units 401 and 402 are added, and photoelectric conversion signals obtained from photoelectric conversion units 403 and 404 are added. On the basis of waveforms of the thus obtained pair of photoelectric conversion signals (image A, image B), a focus state of a subject having a brightness difference (edge) in the Y direction can be detected.

Further, photoelectric conversion signals obtained from photoelectric conversion units 401 and 403 are added, and photoelectric conversion signals obtained from photoelectric conversion units 402 and 404 are added. On the basis of waveforms of the thus obtained pair of photoelectric conversion signals (image A, image B), a focus state of a subject having a brightness difference (edge) in the X direction can be detected.

These two adding methods for focus detection may be performed by dividing a pixel group on the imaging device 106 into blocks and changing the adding methods for each block. For instance, the adding methods may be changed alternately like a checkered pattern arrangement, whereby a pixel layout structure equivalent to FIG. 3 can be achieved. Such a method enables evaluation for a subject in a vertical stripes pattern and a horizontal stripes pattern at the same time, and therefore focus detection can be performed independently of the directions of a subject pattern.

The adding method may be switched depending on the photographing state or for all pixels on a time-series basis. In that case, photoelectric signals in a dense state can be obtained from the focus detection pixels in the Y direction or the X direction. As a result, a problem that a focus state of a subject having thin lines cannot be detected in the vicinity of focusing, which occurs for loose photoelectric conversion signals obtained from the focus detection pixels, can be avoided.

An image can be recorded by adding photoelectric conversion signals obtained from the photoelectric conversion units 401 to 404 for each pixel to obtain a photoelectric conversion signal for each pixel.

The following describes focus detection processing by a phase difference detection method when shake correction is performed using the second lens group 103 in the camera including the imaging device 106 illustrated in FIGS. 2 to 4.

For the focus detection processing by a phase difference detection method using a photoelectric conversion signal obtained from the imaging device 106 having the structure as illustrated in FIGS. 2 to 4, concurrently with focus detection, an image received by the imaging device can be live-view displayed in real time or moving images can be photographed.

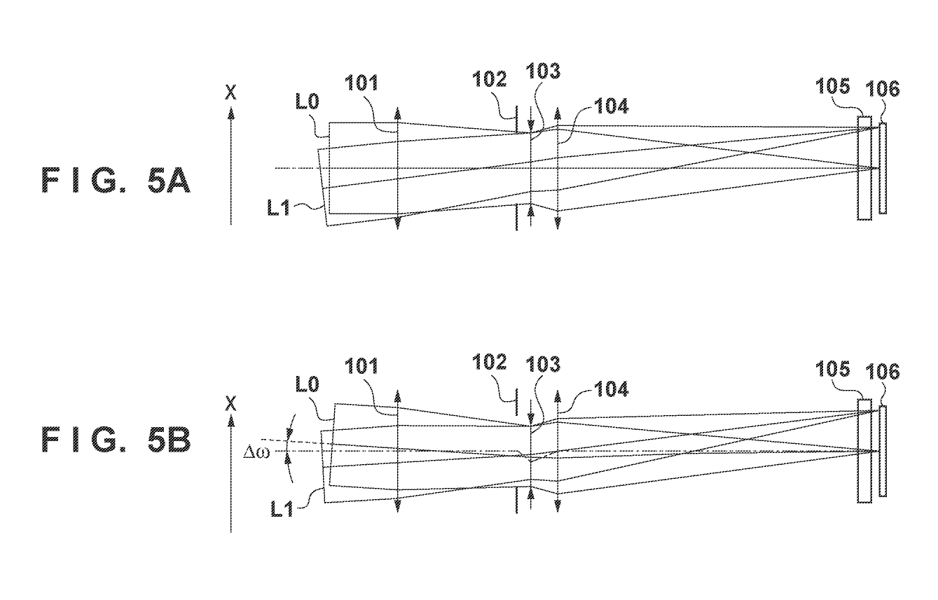

FIGS. 5A and 5B illustrate the state where the second lens group 103 in the photographing optical system is eccentric-shifted for shake correction. In these drawings, the first lens group 101 has a positive refractive power with reference to an object side, the second lens group 103 has a negative refractive power and the third lens group 104 has a positive refractive power. The second lens group 103 is eccentric-shifted in the direction orthogonal to the optical axis to generate an image-forming location displacement action and so cancel image blur. In the drawings, L0 denotes a center light flux and L1 denotes a peripheral light flux.

FIG. 5A illustrates a state before the image blur correction, and FIG. 5B illustrates a state where the second lens group 103 is eccentric-shifted so as to obtain an image blur correction action corresponding to the angle of Δω as a view angle variation. In this state, as illustrated in FIG. 5B, the decentered second lens group 103 causes an effective light range of the second lens group 103 to enter a pupil range of the photographing optical system, resulting in asymmetric photo vignetting occurring with reference to the optical axis.

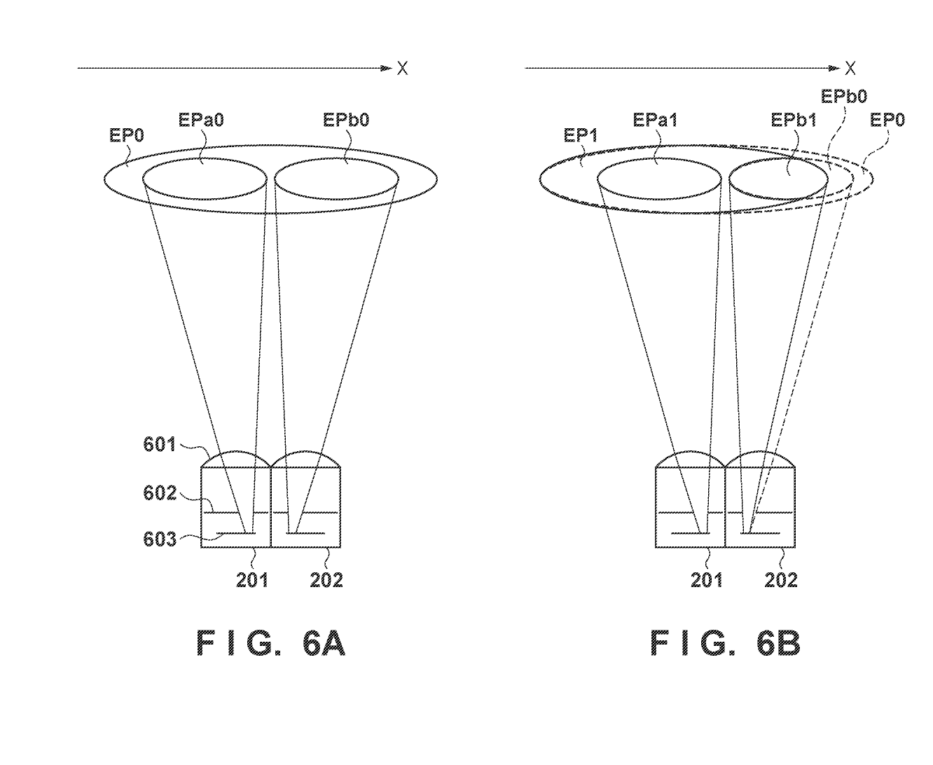

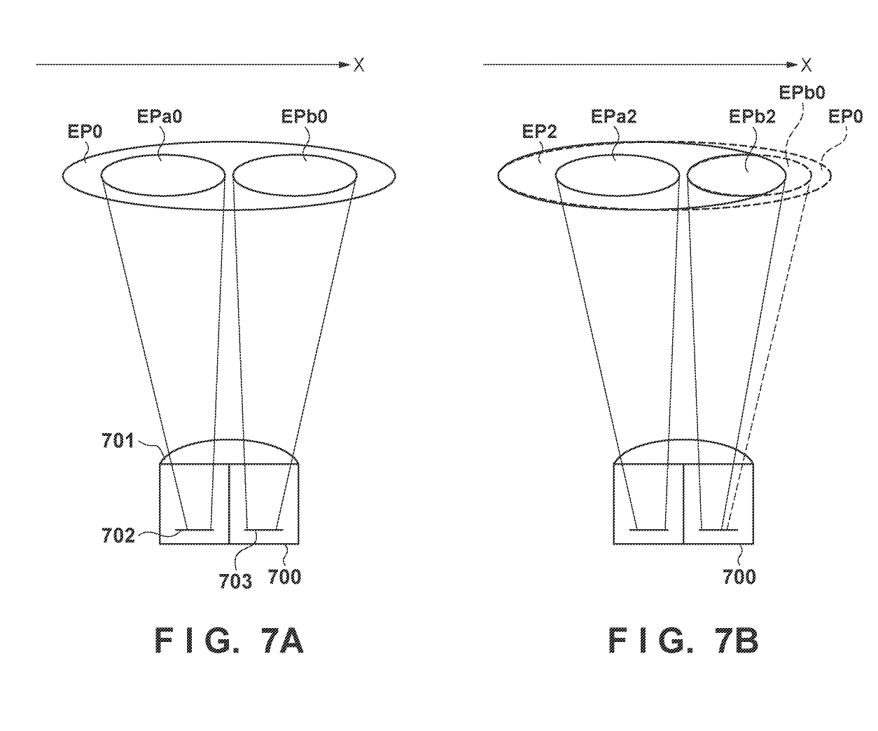

Referring next to FIGS. 6A and 6B and FIGS. 7A and 7B, the influence on the base-line length from photo vignetting caused by the eccentric-shift of the second lens group 103 as illustrated in FIGS. 5A and 5B for focus detection of center image height is described below. In the following description, the photographing optical system having a circular aperture is exemplified.

FIGS. 6A and 6B correspond to FIGS. 5A and 5B, respectively, and illustrate a relationship of pupil projected images at the focus detection pixels to an exit pupil of the photographing optical system. Assume that the imaging device 106 has the structure as illustrated in FIG. 2, and for explanatory convenience, the focus detection pixel 201 and the focus detection pixel 202 are illustrated side by side. FIG. 6A illustrates the second lens group 103 in a not-eccentric state and FIG. 6B illustrates the second lens group 103 in an eccentric-shifted state.

In FIGS. 6A and 6B, at the focus detection pixels 201 and 202, reference numeral 601 denotes a microlens, 602 denotes a light-shielding member and 603 denotes a photoelectric conversion unit. EP0 in FIG. 6A illustrates the exit pupil of the photographing optical system without photo vignetting, and EP1 in FIG. 6B illustrates the exit pupil of the photographing optical system with photo vignetting occurring due to the eccentric-shifting of the second lens group 103 during image blur correction as illustrated in FIG. 5B. EPa0 and EPb0 indicate images, projected on the pupil, of the focus detection pixel 201 and the focus detection pixel 202 for image A and image B, and EPa1 and EPb1 indicate images, projected on the pupil, of the focus detection pixel 201 and the focus detection pixel 202 with a narrowed effective range due to the eccentric-shifting of the second lens group 103.

FIGS. 7A and 7B illustrate a relationship of images, projected on the exit pupil of the photographing optical system, of the focus detection pixels when the focus detection pixels have the structures as illustrated in FIG. 3 and FIG. 4. As illustrated in FIGS. 7A and 7B, a plurality of photoelectric conversion units are provided in each pixel covered with one microlens, and photoelectric conversion units for image A and image B are disposed adjacent to each other. FIG. 7A illustrates the second lens group 103 in a not-eccentric state and FIG. 7B illustrates the second lens group 103 in an eccentric-shifted state. In FIGS. 7A and 7B, a pixel 700 has a plurality of photoelectric conversion units 702 and 703 to receive light via one microlens 701, and each photoelectric conversion unit plays a role to form image A or image B. The photoelectric conversion units 702 and 703 receive light passing through an effective range outside of the optical axis of the microlens 701. Accordingly, each photoelectric conversion unit can receive a light beam passing through a different part of the exit pupil of the photographing optical system, and pupil-divided light beams required for focus detection by the phase difference detection method can be obtained.

When the imaging device 106 has the structure of FIG. 4, and when the photoelectric conversion units 702 and 703 of FIGS. 7A and 7B correspond to the photoelectric conversion units 403 and 404 of FIG. 4, respectively, the photoelectric conversion units 401 and 402 of FIG. 4 exist in the depth direction overlapping the photoelectric conversion units 702 and 703 of FIGS. 7A and 7B.

EP0 in FIG. 7A illustrates the exit pupil of the photographing optical system without photo vignetting, and EP2 in FIG. 7B illustrates the exit pupil of the photographing optical system with photo vignetting occurring due to the eccentric-shifting of the second lens group 103 during image blur correction as illustrated in FIG. 5B. EPa0 and EPb0 indicate images, projected on the pupil, of the photoelectric conversion units 702 and 703 for image A and image B, and EPa2 and EPb2 indicate images, projected on the pupil, of the photoelectric conversion units 702 and 703 with a narrowed effective range due to the eccentric-shifting of the second lens group 103. As understood from FIG. 7B, the eccentric-shifting of the second lens group 103 causes the light effective range of the second lens group 103 to shift inwardly of the exit pupil of the photographing optical system in the state without eccentricity, resulting in occurrence of photo vignetting.

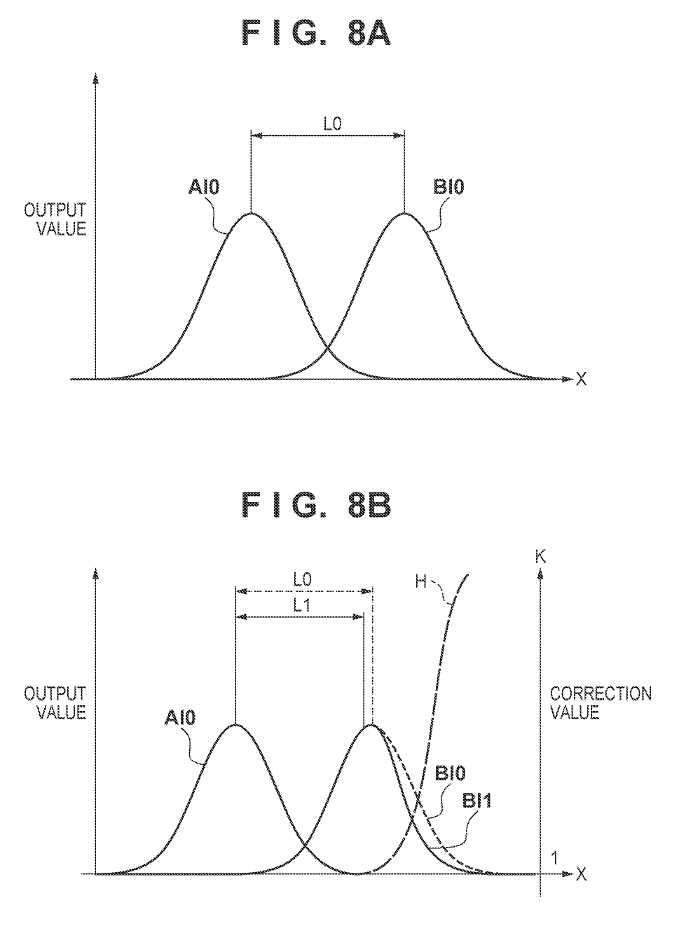

FIGS. 8A and 8B illustrate exemplary waveforms of image A and image B obtained for each different pupil area that is an output from the focus detection pixel group in the states of FIGS. 6A and 6B and FIGS. 7A and 7B. In these drawings, AI0 and BI0 of FIG. 8A, indicate interpolated synthesis of output signals from the pixel groups for image A and image B in the state where photo vignetting by the second lens group 103 does not occur as in FIG. 6A or FIG. 7A. L0 indicate a difference between gravity center positions of signal strength of the waveforms of image A and image B. Similarly, AI0 and BI1 of FIG. 8B indicate interpolated synthesis of output signals from the pixel groups for image A and image B in the state where photo vignetting by the second lens group 103 occurred as in FIG. 6B or FIG. 7B.

Herein, when the pupils of the pixels for image A and image B are vignetted as illustrated in FIG. 6B and FIG. 7B, the output waveforms AI0 and BI1 have an asymmetric shape. As a result, the center position of signal strength varies from that in FIG. 8A in the X direction orthogonal to the optical axis of the photographing optical system, so that the difference L1 between the center positions of signal strength becomes shorter than L0. Accordingly, as compared with the state of FIG. 8A, the base-line length in the state of FIG. 8B becomes shortened under the influence of photo vignetting by the second lens group 103.

H in FIG. 8B indicates a correction curve representing a correction amount decided by the eccentricity amount (shifted coordinates position) of the second lens group 103, and the waveform BI1 of image B is multiplied by a correction value K, whereby a waveform BI0 in the state without photo vignetting can be formed.

Herein, the correction curve H is represented, for example, as the following polynomial function, from which the correction value K is derived for the coordinate X of the waveform BI1 to be corrected:

K(X)=1+a·X+b·X²+c·X³+ . . . .

In this function, coefficients a, b, c, . . . may be changed in accordance with the eccentricity amount of the second lens group 103.

Note here that, the aforementioned example describes the correction in the X direction as one-dimensional direction only. However, correction in the Y direction of the second lens group 103 (depth direction in FIGS. 5A and 5B) may be performed using rectangular coordinates at the same time.

These correction values (or the coefficients a, b, c, . . . ) may be stored in a memory (not illustrated) in the CPU 121 or a nonvolatile memory (not illustrated) in the camera. Then, the eccentricity amount (position) of the second lens group 103 is found on the basis of a driving amount of the correction lens driving circuit 127, and a correction value corresponding to the found eccentricity amount is read out for correction. Alternatively, the position of the second lens group 103 may be detected by a sensor not illustrated, and a correction value corresponding to the detected position may be read out.

As described above, an output signal of the imaging device 106 is corrected in accordance with the eccentricity amount (position) of the second lens group 103, whereby focus detection accuracy can be improved.

In the case of focus detection pixels having the shapes as illustrated in FIGS. 2 to 4, the degree of influence on photo vignetting will vary with a relationship between a line characteristic included in a subject image and a direction of a line where a focus state can be detected and with a shift direction of the second lens group 103 during image blur correction. Therefore, the correction values may be changed in accordance with the degree of influence.

The above describes the case where correction processing is performed to one of a pair of output signals to be subjected to correlation operation which requires correction. However, correction processing may be performed for both of the output signals as needed.

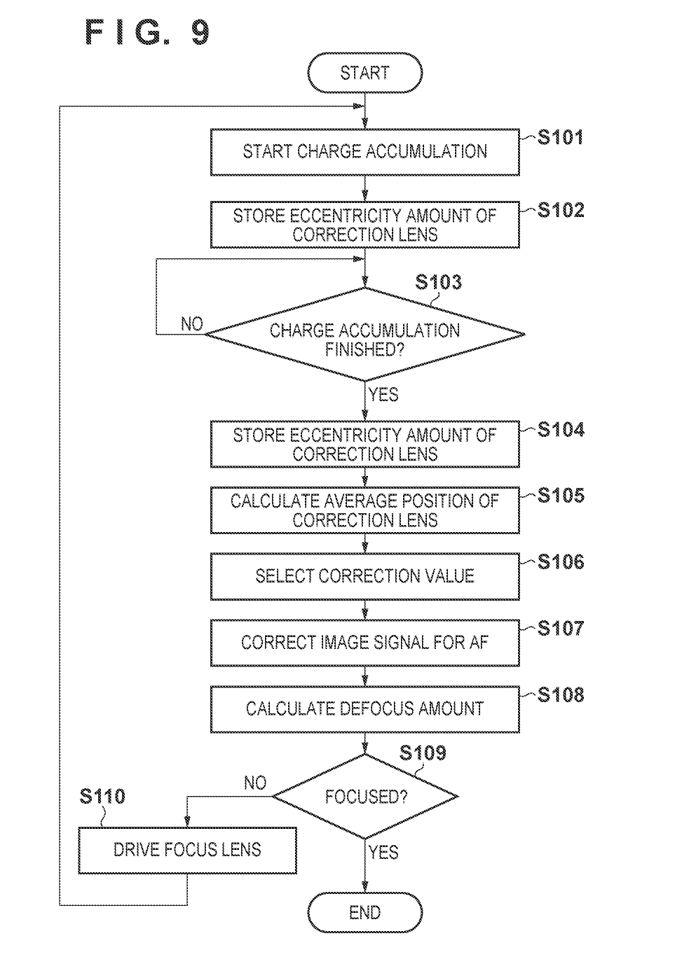

Referring next to the flowchart of FIG. 9, focus detection processing according to the present embodiment is described below.

In response to a switch-on operation of a power supply of a camera by a photographer, the CPU 121 checks operations of various actuators and the imaging device in the camera and initializes the memory and execution programs, while executing a photography preparation operation. Then, in response to the manipulation of a shutter button by the photographer, the second lens group 103 in the photographing optical system starts image blur correction processing together with eccentric-shifting, and focus detection processing is concurrently started.

At Step S101, charge accumulation is started in which light beams incident on the focus detection pixels are converted into an image signal for autofocus control. At Step S102, at the timing when the charge accumulation is started at Step S101, an eccentricity amount (in this example, X and Y coordinate positions with reference to the optical axis position as the origin point of the coordinate) of the second lens group 103 performing image blur correction is stored. At Step S103, determination is made as to whether the charge accumulation started at Step S101 is finished or not, and when it is finished, the procedure proceeds to Step S104.

At Step S104, at the timing when the charge accumulation is finished, the eccentricity amount of the second lens group 103 is stored similarly to Step S102. At Step S105, on the basis of the eccentricity amounts of the second lens group 103 stored at Steps S102 and S104, an average X, Y coordinate position of the correction lens group in the charge accumulation time to obtain image signal for focus detection is calculated. Then, at Step S106, on the basis of the calculation result at Step S105, a correction value corresponding thereto is selected from a memory (not illustrated) that stores the aforementioned correction values.

Then, at Step S107, interpolation processing is performed so as to change a signal waveform of a pair of image signals for AF obtained from the focus detection pixels where the charge accumulation is finished at Step S103 into a signal waveform for correlation operation, and then correction processing is performed using the correction value selected at Step S106.

Next at Step S108, correlation operation is performed to the corrected pair of image signals to calculate an image shift amount, and on the basis of a relationship between the obtained image shift amount and a base-line length found beforehand, conversion into a defocus amount is performed. Herein, the conversion into a defocus amount may be performed using a method described in Japanese Patent Laid-Open No. 2004-191629 or other well-known methods. At Step S109, determination is made as to whether in-focus state is achieved or not on the basis of the obtained defocus amount, and when it is determined as focused, the focus detection processing ends.

On the other hand, when it is determined at Step S109 as not-focused, at Step S110 a focus driving amount toward the in-focus state is found on the basis the defocus amount calculated at Step S108. Then, after the third lens group 104 is driven via the focus driving circuit 126 and the focus actuator 114, the procedure returns to S101 to repeat the aforementioned processing.

The above describes the correction processing for focus state detection while exemplifying the case where the second lens group 103 as a correction lens group of the photographing optical system is eccentric-shifted. The present invention is not limited to this example, and even in the case of shake correction by eccentric-shifting the imaging device 106, correction values corresponding to the eccentricity amounts may be stored in advance similarly, and a correction value may be selected in accordance with the eccentricity amount during shake correction for correction of an image signal.

As described above, according to the present embodiment, an image capturing apparatus provided with an image blur correction mechanism by an optical image stabilization method and configured to perform focus detection on the basis of a signal from an imaging device can achieve high focus detection accuracy.

The present invention is applicable to single-lens reflex cameras and compact digital cameras using an imaging device having focus detection pixels in a phase difference detection method as well as image capturing apparatuses such as a video camera.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-095280, filed on Apr. 21, 2011 which is hereby incorporated by reference herein in its entirety.

What is claimed is:

1. An image capturing apparatus, comprising:
an imaging device configured to receive light fluxes passing through different areas of an exit pupil of an optical system independently and output an image signal obtained therefrom;
a calculation unit configured to calculate a correction value for the image signal corresponding to each of the different areas of the exit pupil to correct an influence from vignetting on the light fluxes due to shift of a shake correction unit in response to activation of the shake correction unit which corrects an image blur corresponding to a shake amount exerted on the image capturing apparatus;
a correction unit configured to correct the image signal corresponding to each of the different areas of the exit pupil using the correction value calculated by the calculation unit; and
a focus control unit configured to perform focus control on a basis of a phase difference between the image signals corresponding to the different areas of the exit pupil, the image signals subjected to correction by the correction unit.

2. The image capturing apparatus according to claim 1, wherein the calculation unit calculates the correction value in accordance with a position of the shake correction unit.

3. The image capturing apparatus according to claim 1, wherein the calculation unit calculates the correction value in accordance with an average position of the shake correction unit in a charge accumulation time period of the imaging device.

4. The image capturing apparatus according to claim 2, further comprising a storage unit configured to store the correction value corresponding to the position of the shake correction unit,
wherein the calculation unit reads out the correction value corresponding to the position of the shake correction unit from the storage unit.

5. The image capturing apparatus according to claim 2, further comprising a storage unit configured to store a coefficient to be used in an expression to find the correction value corresponding to a position of the shake correction unit,
wherein the calculation unit reads out the coefficient corresponding to the position of the shake correction unit, and calculates the correction value using the expression.

6. The image capturing apparatus according to claim 1, wherein the imaging device includes a plurality of pixels including pixels for focus detection capable of receiving light fluxes passing through different areas of an exit pupil of an optical system independently and outputting an image signal obtained therefrom.

7. The image capturing apparatus according to claim 6, wherein the imaging device includes a two-dimensionally arranged plurality of pixels including the pixels for focus detection.

8. The image capturing apparatus according to claim 1, wherein the imaging device includes a plurality of pixels each being provided with a microlens and a plurality of photoelectric conversion units sharing the microlens.

9. A method for controlling an image capturing apparatus, comprising:
a reading step of, from an imaging device configured to receive light fluxes passing through different areas of an exit pupil of an optical system independently and output an image signal obtained therefrom, reading out the image signal corresponding to each the different areas of the exit pupil;
a calculation step of calculating a correction value for the image signal corresponding to each of the different areas of the exit pupil read in the reading step to correct an influence from vignetting on the light fluxes due to shift of a shake correction unit in response to activation of the shake correction unit which corrects an image blur corresponding to a shake amount exerted on the image capturing apparatus;
a correction step of correcting the image signal corresponding to each of the different areas of the exit pupil using the correction value calculated in the calculation step; and
a focus control step of performing focus control on a basis of a phase difference between the image signals of corresponding to different areas of the exit pupil, the image signals subjected to correction in the correction step.
